(19) United States
(12) Patent Application Publication
(10) Pub. No.: US 2014/0282678 A1
(43) Pub. Date: Sep. 18, 2014

(54) Method for Enabling 3DTV on Legacy STB

(71) Applicant: CISCO TECHNOLOGY, INC., San Jose, CA (US)

(72) Inventors: Arturo A. Rodriguez, Norcross, GA (US); James Alan Strothmann, Johns Creek, GA (US); Jeffrey Scott Ford, Madison, AL (US)

(73) Assignee: CISCO TECHNOLOGY, INC., San Jose, CA (US)

(21) Appl. No.: 13/844,734

(22) Filed: Mar. 15, 2013

(51) Int. Cl. H04N 21/45; H04N 21/4363; H04N 5/445; H04N 21/81; H04N 13/04; H04N 9/64

(52) U.S. Cl. CPC H04N 21/4516; H04N 13/0454; H04N 9/642; H04N 5/445; H04N 21/816; H04N 21/43635
USPC 725/25; 725/32

(57) ABSTRACT

Systems and methods may be provided embodying a novel approach to allow a consumer to easily manage the 3D configuration settings of their 3D capable TV set while connected to a legacy video set top box device that has a digital video output port (such as HDMI 1.1-1.3). Stereoscopic (3D) video will be transmitted in one of multiple “frame-packed” or alternating pictures formats that includes both, the compressed picture data of the left and right views, embedded as if it was a regular 2D picture in a standard MPEG2 transport video stream. Deployed (legacy) receivers will decode and output a compressed video stream as if it was a 2D video stream. The stereoscopic image can be delivered in one of the multiple frame-packed formats: side by side (left half and right half adjoined), top half adjoined to bottom half, or according to a checkerboard pattern corresponding respectively to the left view and right view.

### BACKGROUND

While the next-generation set top boxes will have the necessary technology to enable communications to a 3D-capable display device, electronic communication of the specific 3D picture format (either frame-packed or alternating picture) is possible only on latest TV models. Significant volume of Samsung and Mitsubishi TVs support 3D viewing but not the electronic communication that was introduced with High Definition Multimedia Interface (“HDMI”) 1.4 and retrofitted in HDMI 1.3. While

The software of Set Top Boxes (“STB”s) with HDMI 1.3 may be upgraded to support the communication protocol, existing TVs may not. Besides, the HDMI version in some set-tops and/or 3D-capable TVs predate HDMI 1.3. Thus, it is necessary to communicate the 3D format to the subscriber.

### BRIEF DESCRIPTION OF THE DRAWINGS

The accompanying drawings, which are incorporated in and constitute a part of this disclosure, illustrate various embodiments. In the drawings:

FIG. 1 is a block diagram of an operating environment;

FIG. 2 is a flow chart illustrating embodiments of the present disclosure;

FIG. 3 is a flow chart illustrating embodiments of the present disclosure;

FIG. 4 is a flow chart illustrating embodiments of the present disclosure;

FIG. 5 is a block diagram of a computing device.

### DESCRIPTION OF EXAMPLE EMBODIMENTS

Consistent with embodiments of the present disclosure, systems and methods are disclosed allow a consumer to easily manage the 3D configuration settings of their 3D capable TV set while connected to a legacy video set top box device that has a digital video output port (such as HDMI 1.1-1.3). Stereoscopic (3D) video will be transmitted in one of multiple “frame-packed” or alternating pictures formats that includes both, the compressed picture data of the left and right views, embedded as if it was a regular 2D picture in a standard MPEG2 transport video stream. Deployed (legacy) receivers will decode and output a compressed video stream as if it was a 2D video stream. The stereoscopic image can be delivered in one of the multiple frame-packed formats: side by side (left half and right half adjoined), top half adjoined to bottom half, or according to a checkerboard pattern corresponding respectively to the left view and right view.

It is to be understood that both the foregoing general description and the following detailed description are examples and explanatory only, and should not be considered to restrict the application's scope, as described and claimed. Further, features and/or variations may be provided in addition to those set forth herein. For example, embodiments of the present disclosure may be directed to various feature combinations and sub-combinations described in the detailed description.

### DETAILED DESCRIPTION

The following detailed description refers to the accompanying drawings. Wherever possible, the same reference numbers are used in the drawings and the following description to refer to the same or similar elements. While embodiments of this disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A 3D television (3D-TV) is a television set that employs techniques of 3D presentation, such as stereoscopic capture, multi-view capture, or 2D plus depth, and a 3D display—a special viewing device to project a television program into a realistic three-dimensional field. In a 3D-TV signal such as that described in the 3D portion of the HDMI 1.4a specification, which is hereby incorporated by reference in its entirety, three-dimensional images may be displayed to viewing users using stereoscopic images. That is, two slightly different images may be presented to a viewer to create an illusion of depth in an otherwise two-dimensional image. These images may be presented as right-eye and left-eye images that may be viewed through lenses such as anaglyphic (with passive red-cyan lenses), polarizing (with passive polarized lenses), and/or alternate-frame sequencing (with active shutter lenses).

As used throughout the present disclosure, 3D video refers to 3D picture sequences. Within the 3D picture sequences there is a Left picture sequence and a Right picture sequence, wherein each picture of the successive pictures in a Left picture sequence, Pic_Left(n), corresponds to a respective picture of the successive pictures in a Right picture sequence, Pic_Right(n), where n is an integer representing the n-th successive picture in each of the two respective picture sequences. Each corresponding pair of pictures, Pic_Left(n) and Pic_Right(n), also referred to as a corresponding stereo picture pair, are representations of the same visual information but at different viewing angles and intended to be output simultaneously or contemporarily to induce a 3D perception effect.

The successive corresponding Left and Right stereo picture pairs, or processed picture versions thereof, may be output simultaneously on a display device capable of presenting them simultaneously. In an alternate embodiment, the corresponding Left and Right pictures of the successive corresponding stereo picture pairs, or processed picture versions thereof, are output as a Left picture followed by the respectively corresponding Right picture, followed by the successive Left picture followed by the respectively corresponding successive Right picture, and so on.

In embodiments of the present disclosure, a STB authorized to receive a 3D program should instruct the viewer to manually set the TV to 3D display mode, which may be via remote control or physical buttons on the TV or according to the operating instructions of the particular TV. Configuring the TV to the proper 3D video format may be through selection of the 3D Display mode via interactive menus of the TV. The methods presented in this disclosure describe the steps needed to provision the installed base of STBs with 3D video service offerings.

FIG. 1 is a block diagram illustrating an operating environment for providing 3D video to legacy STBs. Note that the video system 100 shown in FIG. 1 is merely illustrative and should not be construed as implying any limitations upon the scope of the preferred embodiments. In this example, the video system 100 includes a 3D video source, such as headend 110. For example, 3D video source 110 may be a 3D video camera coupled to an encoder 120. Encoder 120 may include one or more server devices (not shown) for providing video, audio, and textual data to client devices such as decoder 140.

Encoder 120 may provide the encoded 3D video signal to decoder 140 via a network 130. The network 130 may comprise any suitable mechanisms and/or media for communicating 3D video data including, for example, the Internet, a cable television network or a satellite television network, among others.

Encoder 120 accepts as input, a source 3D video stream from headend 110. Encoder 120 may receive source 3D video stream and through the utilization of any number of compression algorithms translate the source 3D video stream into a transmission 3D video stream.

Decoder 140 may receive the transmission 3D video stream and further restructure the transmission 3D video stream into a display 3D video stream. The display 3D video stream then streamed to a 3D video display device, such as STB 150 via a communications channel. The communications channel may take on a variety of forms such as, wireless or cable or any other form of transmitting data.

STB 150 may be situated at a user's residence or place of business and may be a stand-alone unit or integrated into another device such as, for example, a television set. STB 150 may receive signals corresponding to 3D video programs, each possibly carrying video, audio and/or other data.

Present embodiments may constitute a visual indication to a subscriber of when to configure the TV to 3D display mode. Present embodiments may further provide a visual indication to configure the TV to the 2D (or non-3D) display mode upon exiting a 3D service (program or channel) or upon termination of a 3D program.

If either the STB or TV does not support the electronic communication or protocol that signals the 3DTV format, the subscriber may be informed to set the TV to 3D display mode.

In prior systems, a subscriber would not know when she/he has tuned to a channel (or service) that carries a 3DTV program that she/he has to configure the TV to 3D display mode. In prior system, a subscriber would not know when she/he has tuned away from a 3D program (back to 2D rather than another 3D program) that she/he has to configure the TV to 2D display mode. When the 3D program ends and reverts to 2D service, he/she would not know to set the TV back to 2D display mode. Present embodiments solve these issues.

Before the STB outputs a 3DTV program and is selected or configured to treat the input as a 3DTV signal (frame pack or dual streams), the subscriber may be informed with a barker to configure the TV. The barker may be invoked responsive to a channel carrying a 3DTV program. In an alternate embodiment, the barker may be responsive to a 3D Video on Demand (“VOD”) request. In another embodiment, responsive to the start of a 3D Pay Per View (“PPV”) event, the barker may be presented.

A subscriber may be authorized to view 3D content after subscribing to a 3D video service: broadcast, VOD, or PPV, upon the offering of 3D video services or purchasing a 3D capable TV. When the subscriber of a 3DTV service tunes to a 3DTV program, the STB puts up the barker requesting the subscriber to configure settings in his/her TV for 3DTV display mode.

An additional problem with prior systems is that a subscriber would not know whether their TV is compatible with the particular 3D format of a 3D program or service. Embodiments of the present disclosure authorize a STB for a 3D service only after determining that the TV is capable of ingesting such a service in one or more of the plural 3DTV formats. The determination step may be via the Welcome Screen or General Settings, conducting a series of interactive inquiries that ascertain the 3D capabilities of the TV.

Verification of 3DTV formats supported by TV may be via a “trial and error” phase in which the STB outputs a pattern for subscriber to confirm what she/he sees. In an alternate embodiment, it may be by a priori knowledge of specific TV models' capabilities stored in a database at a headend or specific network location. The subscriber may confirm his/her TV model. A subscriber is considered to be authorized for a 3D service if the 3D format of that service is compatible with the 3D capabilities of the subscriber's TV.

The 3D format of a 3D service corresponds to a video stream that is transmitted as a sequence of coded pictures, in which all pictures correspond to one particular frame-packed format from the following:
A. Frame-packed side by side (left view in the left portion of the picture and the corresponding right view (to the respective left view) in the right portion of the same picture);
B. Frame-packed top and bottom (each picture containing data from the corresponding pair of left and right views);
C. Frame-packed checkerboard (alternating pixels in each picture containing data from the corresponding pair of left and right views);
D. In an alternate embodiment, a fourth 3D format is temporally alternating left and right corresponding pictures (e.g., in 720p/60).

If a TV is capable of ingesting more than one of the 3D formats and authorized via verification of the TV's 3D capabilities, the barker may convey instructions to configure the TV to the 3D format of the 3D program or service (e.g., one of the above four 3D formats).

Frame-packed formats may require subsampling pictures to half of their native picture resolutions to accommodate the corresponding left and right view pair in a single picture, thereafter undergoing compression and transmission as if the video stream was an ordinary 2D video stream. Since frame-packed alternatives exist in which the subsampled approach differs from the frame-packed order, in one embodiment it may be necessary to signal the subsampling approach as well as order of data within the frame-packed pictures.

In other embodiments, the subscriber may be instructed via barker to select between:
A. frame packed, side by side, horizontally subsampled;
B. frame packed, side by side, checkerboard subsampled (but ordered in the picture as side by side);
C. frame packed top bottom (subsampled top lines of the left view and subsampled bottom lines of the right view); and
D. frame pack top bottom (but checkerboard subsampled).

Upon exiting from a non-3DTV program and entering a regular (traditional) 2D service, the subscriber may be asked via the display of a barker to set the TV back to normal 2D display mode. A 2D program is not displayed until viewer provides feedback that he/she has configured TV. Note that the subscriber may turn TV off and leave STB tuned to 3DTV service. The banner to set TV back to 2D may be displayed after subscriber has turned TV off for a period of time and returns.

Furthermore, upon requesting the 3DTV service, instructions may be given to an authorized viewer to set the TV to 3D. Similarly, upon departing a 3D program (or service) or termination of the 3D service, instructions may be given to set TV back to 2D display mode.

Note that service may be broadcast, PPV or VOD. In the case of VOD or PPV, the subscriber is asked same as above (to configure TV for 3D viewing).

In some embodiments, the subscriber is not authorized for a 3DTV service transmitted in a particular 3DTV format unless the network operator confirms that subscriber's TV is compatible to receive and process that particular 3DTV format.

In some embodiments, the cable TV network may offer two 3DTV services. A first 3DTV service is transmitted in a first 3DTV format and a second 3DTV service in a second 3DTV format that is different than the first. A first subscriber with a TV compatible with the first 3DTV format may be authorized for the first 3DTV service. A second subscriber with a TV compatible with the second 3DTV format (e.g., B above) is authorized for second 3DTV service.

In some embodiments, first and second 3DTV services may correspond to different transmissions of the same video program (e.g., Super Bowl). The same content may be transmitted in two different 3DTV formats.

In other embodiments, first and second 3DTV services may correspond to the transmission of different video programs. A third subscriber with a TV compatible to both of the first and second 3DTV formats may be authorized for both of the first and second 3DTV services.

The subscriber may be instructed to select a specific input source of TV (in addition to configuring TV to 3D display mode). The subscriber may be ask to select at least one 3DTV format supported by his/her TV. A trial and error phase that determines TV's 3D capabilities may encompass asking the subscriber to configure TV for 3D display mode and cycling through the outputting for a period of time a respective static picture that corresponds to a 3D format. The subscriber provides input when a sensible 3D picture is observed.

In addition, a set up wizard may be presented to the user to properly determine which 3D mode their TV supports. During the video set top setup process, the user is asked if their TV supports 3DTV. If yes, the user is instructed to select the 3D operation of their TV via remote control or front panel button. The video set top generates a 3D graphic to the TV. The user is asked if the image appears 3D. If yes, the format is added to the list of supported 3D formats, if no, the option is removed. In another instance, the video set top can use the 3D format support table generated by the set up wizard to enable a conversion from one 3D format to another. i.e. video is encoded in top/bottom but TV only supports side by side. The video STB re-encodes the stereoscopic image in the format the TV expects for proper 3D operation.

The 3DTV program may be an event, such as a PPV event. If the subscriber sets reminder for it, then the reminder further instructs the subscriber to configure TV for 3DTV.

In one embodiment, the barker instructing subscriber to set TV back to 2D setting may not be responsive to subscriber tuning to a 2D service but rather responsive to end time of the 3DTV event (PPV).

FIG. 2 is a flow chart illustrating embodiments of the present disclosure. Method 200 may start at step 205 where a 3D video service in a first picture format may be received at a first television. In some embodiments it may first be determined whether the subscriber is authorized for the receipt of the 3D video service. In some embodiments, subscriber authorization further comprises conducting a series of interactive inquires to ascertain 3D capabilities of the first television. 3D capabilities of the first television may even be ascertained from a remote database.

Next, at step 210, a subscriber may be instructed to manually set the first television to a 3D display mode. Instructing a subscriber may further comprise providing a visual indication to configure the television, such as a barker. In some embodiments, the visual indication may be provided responsive to one of a: video on demand request or a start of a pay per view event. In some embodiments one or more patterns may be displayed on the first television. The input from the subscriber may corresponding to the one or more displayed patterns that matches the desired display format.

Method 200 may proceed to step 215 after input is requested from the subscriber. At step 215, the 3D video service may end for any number of reasons. For example, the program may be terminated or the subscriber may select a new program for display. Subsequently, at step 220 the subscriber may be instructed to manually set the first television to a second display mode.

FIG. 3 is a flow chart corresponding to embodiments of the present disclosure. Method 300 may start at step 305 where the 3D capabilities of a first television may be determined. Next, at step 310, the format of a first received video service may be determined. In some embodiments, the subscriber may be authorized if the determined 3D capabilities of the first television are compatible with the format of the first received video service.

Method 300 may next proceed to step 315. At step 315, a first subscriber may be prompted to set the first television to a display mode corresponding to the determined format of the first received video service. Next, at step 320 a requested second television service may be received, wherein the second television service is in a format different from the first received video source.

Upon receipt of the second television service, method 300 may proceed to step 325. At step 325, the first subscriber may be prompted to set the first television to a display mode corresponding to the determined format of the second video service. In some embodiments, the determined format of the first video service is a first 3D format and the format of the second video service is a second 3D format different from the first 3D format. For example, the first 3D format and the second 3D format may be one of: frame-packed side by side, frame-packed top and bottom, and frame-packed checkerboard. The 3D format may further comprise temporally alternating left and right corresponding pictures. Finally, method 300 may proceed to step 330 where the second video service is displayed only after the subscriber provides feedback that the first television is correctly configured.

FIG. 4 is a flow chart illustrating embodiments of the present disclosure. Method 400 may begin at step 405 where a first video program may be displayed in a first display format. Next, at step 410, a request may be received to display a second video program in a second display format different from the first display format.

After receipt of a request to display the second video program, method 400 may proceed to step 415. At step 415, a barker may be displayed requesting a subscriber to set a television to a display mode corresponding to the second display format. In some embodiments, the first display format is 2D and the second display format is 3D. Alternatively, the first display format may be a first particular 3D format and the second display format may be a second particular 3D format different than the first particular 3D format. There, the first video program and the second video program may both correspond to the same content, but in different 3D formats. In some embodiments, the barker itself may be displayed in response to a program reminder.

In some embodiments, the subscriber may select a correct display mode after the system cycles through a plurality of sample 3D format displays to allow the subscriber to set the television to the display mode corresponding to the second display format.

Method 400 may then proceed to step 420. At step 420, the second video program may be displayed in a second display format after confirming that the subscriber has set a television to the display mode corresponding to the second display format. In some embodiments, it may be determined that the subscriber is not authorized for the second video program in the second display format. In that case remote authorization may be requested for the subscriber to view the second video program.

FIG. 5 illustrates a computing device 500. Computing device 500 may include processing unit 525 and memory 555. Memory 555 may include software configured to execute application modules such as an operating system 510 and/or a program guide interface 520. Computing device 500 may execute, for example, one or more stages included in the methods as described above. Moreover, any one or more of the stages included in the above describe methods may be performed on any element shown in FIG. 5.

Computing device 500 may be implemented using a personal computer, a network computer, a mainframe, a computing appliance, or other similar microcomputer-based workstation. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, a wireless fidelity (Wi-Fi) access point, or a facsimile machine. The aforementioned systems and devices are examples and the processor may comprise other systems or devices.

Embodiments of the present disclosure, for example, are described above with reference to block diagrams and/or operational illustrations of methods, systems, and computer program products according to embodiments of this disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

All rights including copyrights in the code included herein are vested in and are the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

What is claimed is:

1. A method comprising:
receiving a 3D video service in a first picture format at a first television;
instructing a subscriber to manually set the first television to a first display mode;
exiting the 3D video service; and
instructing the subscriber to manually set the first television to a second display mode.

2. The method of claim 1, wherein instructing a subscriber further comprises providing a visual indication to configure the television.

3. The method of claim 2, wherein the visual indication is provided responsive to one of a: video on demand request or a start of a pay per view event.

4. The method of claim 3, further comprising:
determining whether the subscriber is authorized for the receipt of the 3D video service.

5. The method of claim 4, wherein subscriber authorization further comprises conducting a series of interactive inquires to ascertain 3D capabilities of the first television.

6. The method of claim 5, further comprising:
displaying one or more patterns on the first television; and
requesting input from the subscriber corresponding to the one or more displayed patterns.

7. The method of claim 5, wherein 3D capabilities of the first television are ascertained from a remote database.

8. An apparatus comprising:
a memory; and
a processor coupled to the memory, wherein the processor is operative to:
determine the 3D capabilities of a first television;
determine the format of a first received video service;
prompt a first subscriber to set the first television to a display mode corresponding to the determined format of the first received video service;
receive a requested second television service, wherein the second television service is in a format different from the first received video source; and
prompt the first subscriber to set the first television to a display mode corresponding to the determined format of the second video service.

9. The apparatus of claim 8, wherein the determined format of the first video service is a first 3D format and the format of the second video service is a second 3D format.

10. The apparatus of claim 9, wherein the first 3D format and the second 3D format are one of: frame-packed side by side, frame-packed top and bottom, and frame-packed checkerboard.

11. The apparatus of claim 9, wherein the second 3D format comprises temporally alternating left and right corresponding pictures.

12. The apparatus of claim 8, wherein the processor is further configured to:
authorize the subscriber if the determined 3D capabilities of the first television are compatible with the format of the first received video service.

13. The apparatus of claim 12, wherein the processor is further configured to: display the second video service only after the subscriber provides feedback that the first television is correctly configured.

14. A method comprising:
displaying a first video program in a first display format;
receiving a request to display a second video program in a second display format different from the first display format;
displaying a barker requesting a subscriber to set a television to a display mode corresponding to the second display format; and
displaying the second video program in a second display format after confirming that the subscriber has set a television to the display mode corresponding to the second display format.

15. The method of claim 14, wherein the first display format is 2D and the second display format is 3D.

16. The method of claim 15, further comprising:
determining that the subscriber is not authorized for the second video program in the second display format; and
requesting remote authorization for the subscriber to view the second video program.

17. The method of claim 14, wherein the first display format is a first particular 3D format and the second display format is a second particular 3D format different than the first particular 3D format.

18. The method of claim 17, wherein the first video program and the second video program both correspond to the same content, but in different 3D formats.

19. The method of claim 17, further comprising cycling through a plurality of sample 3D format displays to allow the subscriber to set the television to the display mode corresponding to the second display format.

20. The method of claim 14, further comprising displaying a barker requesting a subscriber to set a television to a display mode corresponding to the second display format in response to a program reminder.
